(19) United States
(12) Patent Application Publication
(10) Pub. No.: US 2006/0256404 A1
(43) Pub. Date: Nov. 16, 2006

(54) Image recording apparatus and a method of calibrating the same

(75) Inventor: Hideyuki Yamada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/370,972

(22) Filed: Mar. 9, 2006

(30) Foreign Application Priority Data
Mar. 9, 2005 (JP) 2005-065300

(51) Int. Cl. H04N 1/46

(52) U.S. Cl. 358/504

(57) ABSTRACT

The image recording apparatus and calibrating method generate a calibration chart having plural pairs of two patches formed on both surfaces of a recording medium in such a way that two corresponding patches, one on the front surface and the other on the back surface, are at least different in color, measure second image information and second position information showing a formed position on the recording medium for each patch recorded on at least one surface of the formed calibration chart and calculate reference correction amounts based on the measured second image and position information as well as first image information and first position information for each patch used for generating the calibration chart. The apparatus and method calculate amounts of image data correction of the printing image data based on the calculated reference correction amounts and correct the printing image data of the images.

### BACKGROUND OF THE INVENTION

This invention relates to an image recording apparatus capable of forming high-quality image on two-side or both of a front surface and a back surface of a recording medium. The invention also relates to a method of calibrating the image recording apparatus.

The image as recorded on photographic films including negatives or reversals (which are hereinafter collectively referred to as films) is currently printed to a light-sensitive material (printing paper) by means of a digital photoprinter in which the image recorded on the film is read photoelectrically and the signal obtained is converted to a digital signal (image data which represents image densities) and subjected to various image processing steps to produce image data for recording (print signal) and in which the light-sensitive material is exposed with recording light modulated in accordance with the image data, followed by development of the exposed image to output it as a photographic print.

In the digital photoprinter, image is read photoelectrically and subjected to image processing as digital image data and, hence, the colors and densities of the image to be reproduced on a photographic print can not only be corrected in an effective manner; image processing steps such as sharpening and red-eye correction that are basically impossible to perform with the ordinary printer which involves direct exposure can also be carried out to produce high-quality image.

The digital photoprinter does more than outputting the image as a photographic print; the image data for the image reproduced on the photographic print can be outputted as an image file to a variety of recording media including CD-R and MO (magnetooptical recording medium); if desired, the digital photoprinter may receive image data from a recording medium such as CD-R or an imaging apparatus such as a digital camera and outputs a photographic print reproducing the image as formed by that image data.

Not only the digital photoprinter but also other image recording apparatuses that depend on image data for recording image, such as an ink jet printer, a thermal recording apparatus which uses a thermal head, and an electrophotographic image recording apparatus, are required to have a capability of outputting an image that has colors and densities as appropriate for the supplied image data.

However, the difference between individual image recording apparatuses due to output errors and the like from the exposing light source or the recording head, the difference between the characteristics of individual light-sensitive materials on account of the differences from one production lot to another, the variations in developing conditions such as the deterioration of processing solutions and various other factors may cause fluctuations in the conditions of the image output (image recording). As a result, image recording apparatuses often fail to output an image that is appropriate for given image data.

With a view to eliminating these inconveniences and ensuring that an image appropriate for supplied image data is outputted at all times, it has become current practice to calibrate image recording apparatuses.

To output an image appropriate for supplied image data (which represents image densities), an image recording apparatus is provided with a converting LUT (lookup table) as means of converting the supplied image data to print signals that are adaptive to the emission characteristics of the light source (laser), as well as the exposure characteristics of the light-sensitive material and the printing paper (color paper). However, in order to ensure that an image appropriate for given image data will be outputted even in the face of the above-described fluctuations in image output conditions, it is current practice to rewrite (update) the converting LUT itself by calibration or, alternatively, rewrite the exposure conversion LUT in the converting LUT for converting density data to exposure data and/or the calibration LUT also provided in the converting LUT for converting exposure data to a drive value (print signal) for the light source (laser).

In calibration, in general, image data for recording a calibration chart (the data is hereinafter alternatively referred to as “calibration chart data”) is used to cause an image recording apparatus to output a calibration test chart in which monochromatic color patches having predetermined densities (reference densities), for example, those of three primary colors, C (cyan), M (magenta) and Y (yellow), or gray patches also having reference densities are recorded in predetermined gradation steps on a recording medium; the calibration test chart is hereinafter referred to as a “calibration chart”. One then measures the densities of the respective color patches on the calibration chart; alternatively, one measures the densities of the gray patches as they are each separated into the monochromatic colors C, M and Y.

Thereafter, one determines how much the density of each of the monochromatic colors as measured for the patches on the outputted calibration chart (said density is hereinafter referred to as the measured density of each patch's monochromatic color) deviates from the reference density of each of the monochromatic colors of the corresponding patches predetermined by the calibration chart data. Depending on the thus determined deviations, one rewrites either the above-described converting LUT itself or the exposure conversion LUT and/or the calibration LUT.

A variety of methods have heretofore been proposed for performing the above-described calibration of image recording apparatuses (see, for example, JP 2002-77620 A and JP 2003-283833 A).

JP 2002-77620 A discloses an image recording apparatus which, when performing calibration by adjusting the conditions for image signal conversion from a first image signal to a second one, assures precise adjustment even if there are only a small number of patches for the image on a calibration test chart.

The image recording apparatus of JP 2002-77620 A has a recording means of recording image on a recording medium, an image signal converting means which, using the image signal converting condition which represents the relation between the first image signal and the second image signal for recording image by the recording means, converts a signal value of the first image signal to generate a signal value of the second image signal, a density measuring means which, using a test chart output image signal value of the second image signal, obtains a measured density value of a test chart image as recorded by the recording means, a reference density value selecting means which, from target density data which represents the relation between the first image signal and the target density of the image to be recorded on the recording medium and which has a greater number of data points than that of the measured density values as obtained by the density measuring means, selects a reference density value in relation to the measured density value, and a conversion condition calculating means which uses the target density data and the selected reference density value to calculate a test chart target image signal value in relation to the measured density value and which then calculates the image signal converting condition on the basis of the calculated test chart target image signal value and the test chart output image signal value. The image recording apparatus of JP 2002-77620 A records image using the signal values of the second image signal as obtained by conversion from the signal values of the first image signal for the desired image using the calculated image signal converting condition.

JP 2003-283833 A discloses a calibration method which stores not only a calibration computing module related to an already installed old densitometer but also a calibration computing module related to a new densitometer different from the old densitometer, the new densitometer being provided with means of outputting identification information for identifying the model of densitometer, and which, when performing calibration, determines whether the densitometer installed is an old or a new one in view of the identification information being outputted from the new densitometer, and employs the relevant calibration computing module according to the result of that identification.

There was also proposed an image recording apparatus of a type that records images on two-side (both surfaces) of a recording medium (see JP 2003-266803 A). In connection with this dual type of image recording apparatus, a method was proposed for calibrating the images recorded on two-side of the recording medium (see JP 2003-154629 A).

In the image recording apparatus of JP 2003-266803 A, a first and a second recording section are provided along a recording sheet transport path in such a way that both recording sections face the first side of a recording sheet. A branching guide and a feed direction changing section are provided between the first and second recording sections. The branching guide can be displaced by a horizontal shift mechanism to move between a branch guide position and a return guide position and by a vertical shift mechanism to move between either of the two guide positions and a retracted position. In a two-side print mode, a front surface image is recorded on the first side of the recording sheet in the first recording section. The recording sheet is then sent to the feed direction changing section via the branching guide that has been set in the branch guide position. After the trailing end of the recording sheet emerges from the branching guide, the feed direction changing section is caused to change its feed direction and the recording sheet is sent to the second recording section by means of the branching guide that is now set in the return guide position. In the second recording section, a back surface image is recorded on the second side of the recording sheet. In a one-side print mode, the recording sheet is sent to each recording section, where a front surface image is recorded.

As a result, the image recording apparatus of JP 2003-266803 A enables efficient printing whether it is in a two-side or one-side mode.

The print density control apparatus for a two-side printing machine that is disclosed in JP 2003-154629 A comprises a display means for displaying the difference between a target density value and a density value of printed matter for each inking device, a what-to-correct inputting means by which any inking device to be subjected to color correction can be selected from those density values for the respective inking devices that are displayed on the display means, and an ink volume control means by which the ink volume in the inking device that has been selected by the what-to-correct input means is controlled on the basis of the density difference related to that inking device. The display means is adapted to be capable of displaying the density differences for the front surface of the printed matter and those for its back surface and the what-to-correct input means is adapted to be capable of selection between an inking device for front surface printing and an inking device for back surface printing.

However, the prior art techniques described above have their own problems that need to be solved. The image recording apparatus of JP 2002-77620 A and the calibration method of JP 2003-283833 A both concern a calibration method that is applicable to an image recording apparatus that records image solely on one side of a recording medium and neither relates to a calibration method that is applicable to an image recording apparatus that can perform image recording on two-side of the recording medium.

The print density control apparatus of JP 2003-154629 A is intended to control the printing densities for image recording on two-side of a recording medium; however, it does not take into account the effect the image recorded on the front surface of the recording medium might have on the image recorded on the back surface and vice versa, As a result, even if calibration is separately performed for each of the front and back surfaces of the recording medium, the image on either side may affect the image on the other side, causing variations in the image density on each side and its appropriateness is not necessarily guaranteed. Because of this problem, the quality of printed matter cannot be guaranteed with images being recorded on two-side.

### SUMMARY OF THE INVENTION

The present invention has been accomplished under these circumstances and has as an object providing an image recording apparatus that can form high-quality images on two-side or both surfaces of a recording medium.

Another object of the present invention is to provide a method for calibrating the apparatus.

In order to achieve the above objects, a first aspect of the present invention provides an image recording apparatus comprising: an image forming unit which forms an image or images on a front surface, a back surface or both of a recording medium based on printing image data; a chart generating section which generates chart image data for generating a calibration chart which has plural pairs of two patches formed on front and back surfaces of the recording medium in such a way that two corresponding patches of one pair, one on the front surface and the other on the back surface, are at least different in color, and outputs the chart image data as the printing image data to the image forming unit, as well as stores first image information and first position information showing a position to be formed on the recording medium for each patch of the plural pairs of two patches to be formed on both surfaces of the calibration chart; an acquisition unit which acquires second image information and second position information showing a formed position on the recording medium for each patch recorded on at least one surface of the calibration chart formed by the image forming unit based on the chart image data output from the chart generating section; a computing section which, based on the second image information and the second position information for each patch that have been acquired by the acquisition unit as well as the first image information and the first position information for each patch that have been stored by the acquisition unit, calculates reference correction amounts for recording image on both the front and back surfaces in the chart generating section; and a printing image data correcting section which calculates amounts of image data correction of the printing image data for each of pixels in each of the images based on the calculated reference correction amounts, image information for each of pixels in each of the images to be formed on the front and back surfaces of the recording medium and position information to be formed for each of the pixels in each of the images on the front and back surfaces of the recording medium, and corrects the printing image data of the images for forming on the front and back surfaces of the recording medium using the calculated amounts of image data correction, wherein the image forming unit forms, based on the printing image data corrected by the printing image data correcting section, the images on the front and back surfaces of the recording medium, respectively.

Preferably, the image recording apparatus further includes a recording medium species-related information section which stores transmittance and reflectance of the recording medium, and the computing section calculates the reference correction amounts in consideration of the transmittance and the reflectance of the recording medium stored in the recording medium species-related information section.

A second aspect of the present invention provides a method of calibrating an image recording apparatus which is capable of forming an image or images on a front surface, a back surface or both of a recording medium based on printing image data, comprising the steps of: calibrating image formation due to the image recording apparatus on each of front and back surfaces of the recording medium; generating with the image recording apparatus a calibration chart which has plural pairs of two patches formed on front and back surfaces of the recording medium in such a way that two corresponding patches of one pair, one on the front surface and the other on the back surface, are at least different in color; measuring second image information and second position information showing a formed position on the recording medium for each patch recorded on at least one surface of the formed calibration chart: and calculating reference correction amounts for recording image on both the front and back surfaces of the recording medium based on the second image information and the second position information for each patch that have been measured as well as first image information and first position information for each patch that have been used for generating the calibration chart with the image recording apparatus.

Preferably, the method further comprises the steps of: calculating amounts of image data correction of the printing image data for each of pixels in each of the images based on the calculated reference correction amounts, image information for each of pixels in each of the images to be formed on the front and back surfaces of the recording medium and position information to be formed for each of the pixels in each of the images on the front and back surfaces of the recording medium; and correcting the printing image data of the images for forming on the front and back surfaces of the recording medium using the calculated amounts of image data correction.

Preferably, the step of calculating the reference correction amounts calculates the reference correction amounts in consideration of transmittance and reflectance of the recording medium.

The image recording apparatus according to the first aspect of the present invention offers the advantage that if each of the images formed on the front and back surfaces of the recording medium are likely to affect the image on the other side by, for example, changing the color tints and densities of that image, such possible effects can be sufficiently suppressed that the resulting image is corrected to have the same quality as the image that would be obtained by recording on one side only. Consequently, when image is to be formed on both the front and back surfaces of the recording medium, image forming is possible on each of the front and back surfaces of the recording medium on the basis of the printing image data as corrected by the printing image data correcting section. This contributes to forming high-quality image on two-side or both surfaces of the recording medium.

The method of calibrating the image recording apparatus according to the second aspect of the present invention is capable of calculating the reference correction amounts for recording image on both the front and back surfaces of the recording medium. The thus calculated amounts of correction are sufficient to offer such an advantage that if each of the images formed on the front and back surfaces of the recording medium are likely to affect the image on the other side by, for example, changing the color tints and densities of that image, such possible effects can be sufficiently suppressed that the resulting image is corrected to have the same quality as the image that would be obtained by recording on one side only. Consequently, high-quality image can be formed on two-side of the recording medium using the image recording apparatus as calibrated by the above-described method of the invention.

### BRIEF DESCRIPTION OF THE DRAWINGS

FIG. 1 is a schematic diagram showing an image recording apparatus according to an embodiment of the present invention;

FIG. 2 is a block diagram showing the control unit of the image recording apparatus depicted in FIG. 1;

FIG. 3A is a schematic diagram showing the pattern of the image on the front surface of a recording medium;

FIG. 3B is a schematic diagram showing the pattern of the image on the back surface of the recording medium;

FIG. 3C is a schematic diagram showing the amounts of image data correction by which the respective pixels in the image on the front surface of the recording medium are to be corrected; and

FIG. 3D is a schematic diagram showing the amounts of image data correction by which the respective pixels in the image on the back surface of the recording medium are to be corrected.

### BEST MODES FOR CARRYING OUT THE INVENTION

On the pages that follow, the image recording apparatus of the present invention and the method of calibrating it are described in detail with reference to the preferred embodiments shown in the accompanying drawings.

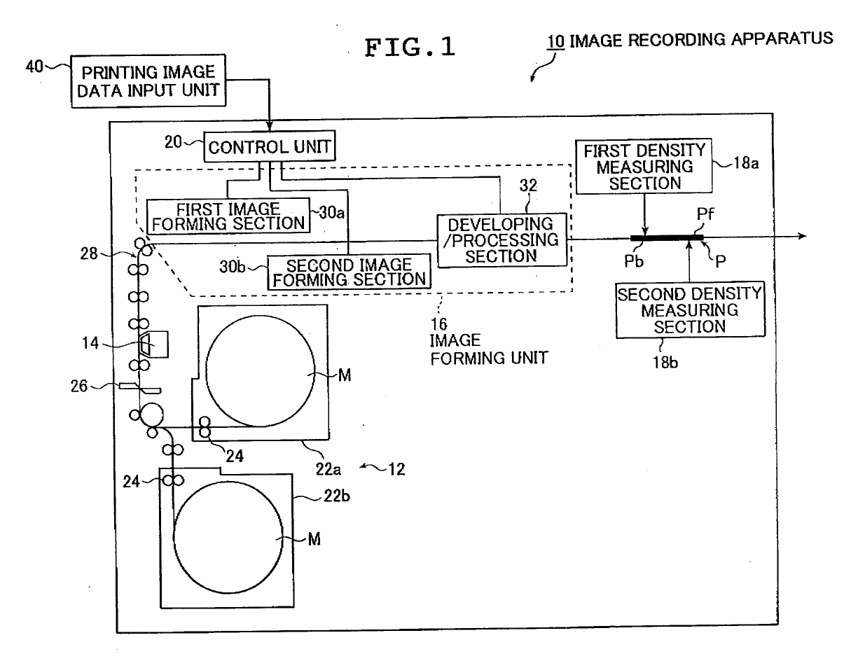

FIG. 1 is a schematic diagram showing an image recording apparatus according to an embodiment of the present invention.

The image recording apparatus generally indicated by 10 in FIG. 1 is of a dual recording type which is capable of image recording on two-side or both surfaces of a recording medium (light-sensitive material) M.

The image recording apparatus 10 exposes the recording medium M for recording purposes by employing scan exposure to an optical beam. In a typical example, a rolled web of recording medium M is withdrawn by a predetermined length and cut to a length of recording medium in sheet form (which is hereinafter sometimes referred to as a sheeting) M; the sheeting M is transported to an exposing position (not shown); as a light beam modulated in accordance with the printing image data supplied from a printing image data input unit 40 is deflected in a main scanning direction, the recording medium M is transported for scan in an auxiliary scanning direction perpendicular to the main scanning direction; in this way, the recording medium M is subjected to scan exposure by means of the optical beam (not shown). Note that the recording medium M has a light-sensitive layer formed on both the front and back surfaces of a substrate in web form.

The image recording apparatus 10 comprises a feed unit 12, a back printing unit 14, an image forming unit 16, a first density measuring section 18a, a second density measuring section 18b, a control unit 20, and a transport means 28 for withdrawing the recording medium from the feed unit 12 and transporting it through the subsequent stages except the control unit 20. The control unit 20 controls the overall operation of the image recording apparatus 10. The first density measuring section 18a and the second density measuring section 18b constitute the acquisition unit of the present invention.

The image recording apparatus 10 according to the embodiment under consideration is connected to the printing image data input unit 40, which functions to enter printing image data into the image recording apparatus 10.

The printing image data input unit 40 may be in the form of an order accepting machine (not shown). This is a device installed in print shops, convenience stores and other points of sale for accepting orders such as for making prints from a digital image. The order accepting machine reads an image (digital image) from a recording medium that stores it as it was taken with an imaging device such as a digital camera (hereinafter abbreviated as DSC) or a cell phone with imaging capability; if necessary, the machine displays the thus read image on the monitor it has; the machine also has the ability to receive an input of order information as to how many prints should be made for each image, their print size, information about the instruction for finishing, and a variety of special treatments that need to be performed. The digital image received by the order accepting machine is sent via a predetermined communication means and inputted into the image recording apparatus 10 as printing image data.

When the order information is inputted and the order becomes firm, the order accepting machine may not only add order number to the order information but also record the date and time of order acceptance. In addition, the machine checks the order information and if the customer is found to have been previously entered, he or she is assigned the current effective customer ID. If the customer is found not to have been previously entered, he or she is assigned a new customer ID. In this way, the order accepting machine adds the order number, order date and time, and customer ID to the order information and outputs the overall information to the image recording apparatus 10 together with the digital image for which print making has been requested.

The order accepting machine may optionally have a media drive for reading out the printing image data and the like from media such as memory cards, CDs, MOs and FDs.

Another device that may be used as the printing image data input unit 40 is a scanner that photoelectrically reads an object's image formed on a negative film or a photographic print having an image recorded thereon, thereby acquiring the digital image data for the image recorded on the negative film or the photographic print. The digital image data as acquired by the scanner is outputted to the image recording apparatus 10 as the printing image data.

The scanner may be of a type that picks up transmitted light by which the image formed on a negative film or the like is photoelectrically read one frame at a time. It comprises a light source, a variable diaphragm, a color filter plate that separates the image into three primary colors R (red), G (green) and B (blue) by three color filters R, G and B which are selectively inserted into the optical path by rotating the filter plate, a diffusion box that allows the reading light incident on the film to become uniform across the film in its plane, an imaging lens unit, a CCD sensor which is an area sensor for reading one frame of the image on the film, an AMP (amplifier), and a data processing unit in which the R, G and B output signals are subjected to various steps such as A/D (analog to digital) conversion, Log conversion, DC offset correction, dark current correction, and shading correction.

A plurality of dedicated carriers are available for the scanner and they can be selectively attached to the body of the scanner depending upon various factors such as film type (e.g. a film of an advanced photo system or a 135 negative or reversal film) or film format (e.g. size, strip or slide); by replacing one carrier with another, the scanner can be adapted for a variety of films and processing schemes. The image (frame) recorded on a film and subjected to print making is transported to a predetermined reading position by the carrier and held in that position. As is well known, a magnetic recording medium is formed on a film of an advanced photo system and the cartridge ID, film species or like information is recorded on that medium; during shooting, development or some other time, the medium can also record a variety of data as exemplified by the shooting date and time, use or non-use of an electronic flash during shooting, magnification, shot scene ID, information about the position of the principal area, and the type of the processor. The carrier adapted for a film (cartridge) of an advanced photo system is provided with means of reading such magnetic information and as the carrier transports the film to the reading position, the reading means reads the magnetic information, whereupon the variety of information as exemplified above is sent to the image recording apparatus 10.

In the scanner under discussion, the reading light issued from the light source has its quantity adjusted by the variable diaphragm, then passes through the color filter plate for color adjustment, and is finally diffused in the diffusion box; the diffused reading light is launched into one frame of the film as it is held in a predetermined reading position by the carrier; the light then transmits the frame, giving rise to projected light which bears the image in that frame as it has been recorded on the film. The projected light from the film is focused on the image-receiving plane of the CCD sensor by the imaging lens unit and read photoelectrically by the CCD sensor; the resulting output signal is amplified by the AMP and sent to the image recording apparatus 10. The CCD sensor may be an area CCD sensor consisting of 1380×920 pixels.

In the scanner, such image reading process is performed three times by successively inserting the respective color filters on the color filter plate, whereupon an image of one frame is read as it is separated into the three primaries R, G and B.

In the foregoing embodiment, the scanner uses an area CCD sensor and adjusts the reading light by means of the color filter plate so that the original image (the projected light from the film) is read as it is separated into the three primaries. Alternatively, the image recording apparatus 10 of the present invention may be supplied with image data by a scanner that performs image reading by so-called “slit scan”, which uses three line CCD sensors that are respectively associated with the reading of the three primaries R, G and B and in which the image on the film is read with a slit of reading light (projected light) as it is transported for scan by the carrier.

In the image recording apparatus 10 of the embodiment under consideration, the printing image data input unit 40 is in no way limited to digital image input means such as DSC, PC, or a cell phone with imaging capability, and a variety of means can be employed as long as they have a digital image acquiring section in any other format that has the imaging capability and if they can be connected to the image recording apparatus 10 by communication means as will be described later in this specification. Examples of such alternative means include a digital video camera and PDA (personal digital assistant).

The DSC has a display which is typically intended to display the image taken. The PC is just like a common personal computer and comprises a main unit, a display, and manipulating means such as a mouse and a keyboard. The cell phone with an imaging capability also has a display which is typically intended to display a function selection screen and the image taken.

In addition to the capabilities they usually have as a device (apparatus), each of the DSC, PC and the cell phone with an imaging capability features the ability to enter order information in the same manner as the order accepting machine.

In each of the order accepting machine, DSC, PC, and the cell phone with an imaging capability, the means of entering order information may be of a known type that employs GUI (graphical user interface) or like display systems in combination with a keyboard, a mouse, a touch panel, manipulating keys, manipulating buttons, a display, and like input devices.

In the image recording apparatus 10 according to the embodiment under consideration, the feed unit 12 supplies the recording medium M and it is a site where magazines 22a and 22b are loaded. Each of the magazines has a web of recording medium M, typically wound up in a roll, contained in a light-tight case.

The magazines 22a and 22b usually accommodate two kinds of recording medium M which are different in various respects such as the size (width) of the recording medium M, the type of the light-sensitive surface (e.g, silk- or matte-finish) and the specifications (thickness and the type of the base). In the embodiment under consideration, two magazines 22a and 22b are provided but the number of magazines is not particularly limited in the present invention. Just one magazine or three or more magazines may be used in the present invention.

Note that either one of the magazines, say, magazines 22a and 22b contains a recording medium that has a light-sensitive layer formed solely on the front surface of a substrate in web form. One-sided prints are made using this recording medium having a light-sensitive layer formed on the front surface only.

The magazines 22a and 22b are each provided with a withdraw roller pair 24 for withdrawing the recording medium M from within the magazine for subsequent transport.

A cutter 26 is provided at a predetermined distance away from the exit of each of the magazines 22a and 22b.

The withdraw roller pair 24 stops withdrawing the recording medium M after it has withdrawn a predetermined length of the medium M in accordance with the print length so that it is cut to a predetermined length of sheeting with the cutter 26.

In response to a control signal sent from the control unit 20, the cutter 26 cuts the recording medium M that has been withdrawn from the magazine 22a or 22b and the interval at which the cutter 26 cuts the recording medium M is adjusted by the control unit 20. The recording medium M that has been cut to a predetermined length of sheet with the cutter 26 is sent to the back printing unit 14. In the embodiment under consideration, the feed unit 12 is in no way limited to the type of cutting a web of recording medium M into sheetings which are then supplied to the downstream stages; alternatively, it may be of such a type that it supplies preliminarily formed sheetings of a predetermined size. If desired, one cutter may be provided for each magazine.

If desired, the type of the recording medium M contained in each of the magazines 22a and 22b may be recorded in bar codes, which are read with a reader that may be provided in the feed unit 12 into which the magazines 22a and 22b are to be loaded. The bar codes read in this way may be outputted to a recording medium species-related information unit 62 in the control unit 20 to be described later, whereupon the type of the recording medium M is specified.

The back printing unit 14 is specifically intended for one-side printing, or the recording of an image solely on the front surface of the recording medium in sheet form; in this case, various kinds of information, commonly called “back print”, such as the date of taking a picture, the date of printing, frame number, film ID number (symbol), the ID number of the camera used in picture taking, the ID number of photoprinter, etc. are recorded (back printed) on the back surface of the sheet by the back printing unit 14 in response to a control signal from the control unit 20. Having this function, the back printing unit 14 comprises a roller pair for transporting the sheet of recording medium and a back printing head (not shown).

The sheeting, as it is transported upward by rollers and roller pairs, has the back print recorded on the back surface by means of the back printing head. The back printing unit 14 may comprise a known print head such as an ink-jet head, a dot impact print head or a thermal transfer print head.

The image forming unit 16 forms (records) image on both the front and back surfaces of the recording medium M. The image forming unit 16 typically comprises a first image forming section 30a which forms an image (latent image) on the front surface of the recording medium M, a second image forming section 30b which forms an image (latent image) on the back surface of the recording medium M, and a developing/processing section 32 for developing the latent image formed on the front and back surfaces of the recording medium M. With the exception of their layout, the first image forming section 30a and the second image forming section 30b have the same configuration and allow for image recording in the same manner. Therefore, the following description concerns only the configuration of the first image forming section 30a and the configuration of the second image forming section 30b will not be described.

The first image forming section 30a may be a known optical beam scanning device which employs a laser beam or other optical beam as the recording light. The optical beam scanning device typically comprises light sources that issue optical beams responsible for red (R) exposure, green (G) exposure and blue (B) exposure, respectively, of the sheet of recording medium M, as well as modulating means such as an AOM (acoustooptical modulator) that modulates the issued optical beams in accordance with the printing image data being supplied from the printing image data input unit 40 after it has been subjected to image processing, a light deflector such as a polygonal mirror that deflects the modulated optical beams in a direction (main scanning direction) perpendicular to the direction of transport, and a mirror for adjusting the optical path of an fθ (scanning) lens by which each of the optical beams deflected in the main scanning direction is focused at a specified point in the exposing position as a beam of a specified diameter.

The first image forming section 30a may also be digital exposing means that uses a variety of light-emitting arrays and space modulator arrays that extend in the main scanning direction perpendicular to the direction of transport, as exemplified by a PDP (plasma, display) array, an ELD (electroluminescent display) array, an LED (light-emitting diode) array, an LCD (liquid-crystal display) array, a DMD (digital micromirror device, registered trademark) array, a laser array, etc.

Note that the width of main scanning the first image forming section 30a performs with optical beams in the exposing position is set in such a way that it accommodates differing widths of the recording medium M in sheet form. The above-described action of the first image forming section 30a is controlled by a control signal from the control unit 20.

The optical beams as the recording light are deflected in the main scanning direction whereas the sheet of recording medium M is transported by auxiliary scanning roller pairs; hence, the optical beams modulated in accordance with the image data perform two-dimensional scan exposure on the sheet of recording medium M to record image.

The configuration of the first image forming section 30a is not limited in any particular way as long as the action of scan recording in the main scanning direction perpendicular to the direction of transport of the sheet of recording medium M allows for image recording on the sheet in transport.

The first image forming section 30a further includes delivery means (not shown) by which the sheet of recording medium M that has been subjected to two-dimensional scan exposure by the optical beams is caused to exit therefrom.

The developing/processing section 32 is provided downstream of the second image forming section 30b. In the developing/processing section 32, the sheet of light-sensitive material bearing the exposed latent image is given specified development and subsequent processes including drying, thereby rendering the sheeting into a photographic print that reproduces the image that was recorded on the film. The developing/processing section 32 has a developing subsection (not shown) and a drying subsection (not shown).

The developing subsection has the following tanks arranged horizontally in order from the upstream end of the direction in which the sheeting is transported: a developing tank (not shown) for developing the sheeting and a bleach/fix tank (not shown) for fixing the developed image, as well as the first wash tank (not shown), the second wash tank (not shown), the third wash tank (not shown) and the fourth wash tank (not shown), each for washing the sheeting with water. The drying subsection for drying the sheeting that has been developed and otherwise processed is provided downstream of the fourth wash tank.

In the developing/processing section 32, the exposed image is developed in the developing tank in the developing subsection and fixed in the bleach/fix tank; the sheeting is then washed with water in the first, second, third and fourth wash tanks; in the drying subsection, the sheeting is dried, typically with a heater (not shown) and a blower (not shown), to make a photographic print.

The drying subsection is connected to delivery means (not shown) which causes the photographic print to leave the image recording apparatus 10.

Provided downstream of the developing/processing section 32 are the first density measuring section 18a and the second density measuring section 18b which are located in directions perpendicular to the direction of transport of the photographic print P such that the first density measuring section 18a faces the front surface Pf of the print P whereas the second density measuring section 18b faces its back surface Pb. The first density measuring section 18a and the second density measuring section 18b have the same configuration, so the following description concerns only the configuration of the first density measuring section 18a and the configuration of the second density measuring section 18b will not be described.

The first density measuring section 18a measures the density (image information) for each of the patches on the calibration chart and the position of image formation (the first position information) for each patch in the process of calibration of the photographic print P as an output from the image recording apparatus 10. To this end, the first density measuring section 18a has a known densitometer that has the performance required of the calibration to be effected in the present invention.

The first density measuring section 18a also has a two-dimensional stage that is movable in two perpendicularly crossed directions for measuring the density of each of the patches on the calibration chart. The positions in which the respective patches are formed on the calibration chart are specified by calibration chart data. As a result, if the two-dimensional stage is moved on the basis of the calibration chart data and the density of each patch measured with the densitometer, one can measure not only the density of each patch but also the position in which each patch forms image on the calibration chart.

The densitometer in the first density measuring section 18a may be exemplified by one featuring the following: it has LEDs as light sources issuing R (red), G (green) and B (blue) lights, respectively; it measures the density of a gray patch on the calibration chart after it is separated into the three primary colors and from the results of measurements of the individual monochromatic colors, it can obtain the C (cyan), M (magenta) and Y (yellow) densities of the gray patch; it also measures the densities of the three primaries of the color patches on the calibration chart and from the results of these measurements, it can obtain the C, M and Y densities for the individual monochromatic colors. Another densitometer that may be used in the first density measuring section 18a has a white light source which issues white light, is equipped with filters that transmit R, G and B lights, respectively, and measures the densities of the three primary colors in the manner just described above, thereby obtaining the C, M and Y densities for the individual monochromatic colors.

The densitometer in the first density measuring section 18a is not limited to the one that measures the C, M and Y densities using the R, G and B lights, respectively. Another candidate is a densitometer that measures the reflection brightness of the gray patch using white light and which calculates the densities of the individual monochromatic colors, namely, the C, M and Y densities, from the measured gray's reflection brightness. Alternatively, reflection brightness may be measured for each of the monochromatic colors in the color patches and the densities of the individual monochromatic colors C, M and Y are calculated from the measured reflection brightness of each monochromatic color.

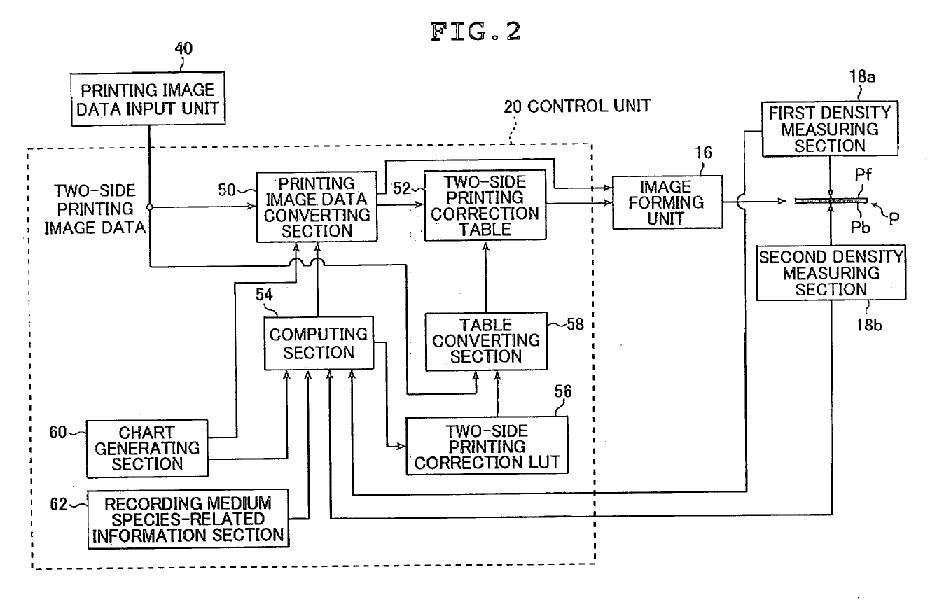

As shown in FIG. 2, the control unit 20 has a printing image data converting section 50, a two-side printing correction table 52, a computing section 54, a two-side printing correction LUT 56, a table converting section 58, a chart generating section 60, and a recording medium species-related information section 62.

The two-side printing correction table 52 and the table converting section 58 combine to constitute the printing image data correcting section of the present invention.

The printing image data converting section 50 in the control unit 20 is connected to the image forming unit 16; it is also connected to the printing image data input unit 40, the computing section 54, and the chart generating section 60.

The two-side printing correction table 52 is connected to the image forming unit 16, the printing image data converting section 50, and the table converting section 58.

The computing section 54 is connected to the first image density measuring section 18a, the second image density measuring section 18b, the two-side printing correction LUT 56, the chart generating section 60, and the recording medium species-related information section 62.

The two-side printing correction LUT 56 is connected to the table converting section 58.

The printing image data converting section 50 is a means by which the printing image data entered from the printing image data input unit 40 is converted to outputting image data that can be outputted from the image forming unit 16 as a photographic print. The printing image data converting section 50 also has a basic image processing capability of applying basic image processing schemes to the printing image data for outputting an image that is appropriate in such respects as the image color/density (tone reproduction and color reproduction) and the image structure (sharpness and graininess); by this basic image processing, the printing image data is rendered complete in image quality. The basic image processing schemes include, for example, image enlargement or reduction (electronic scaling), gradation correction, color/density correction, saturation correction, and sharpening.

The printing image data converting section 50 also has a capability of changing the destination of output depending on the printing image data as entered from the printing image data input unit 40. Consider, for example, the case of tagging order information to the printing image data as to whether printing should be done on one side or two-side; if the order information given is for recording image on one side, the printing image data converting section 50 allows the printing image data to be outputted to the image forming unit 16; if the order information is for recording on two-side, the printing image data is outputted to the two-side printing correction table 52.

To convert the printing image data to the outputting image data in the printing image data converting section 50, a LUT may be employed. The LUT is set or modified during calibration on the basis of the result of calculation by the computing section 54.

The LUTs in the printing image data converting section 50 are used to form image on either the front surface or the back surface of the recording medium, and the printing image data converting section 50 has two LUTs, one for image forming on the front surface and the other on the back surface.

The basic image processing capability possessed by the printing image data converting section 50 may be provided in the printing image data input unit 40; the position where the basic image processing capability is provided is not particularly limited as long as the basic image processing can be applied to the printing image data at a stage before it is outputted to the image forming unit 16.

The two-side printing correction table 52 suppresses the effect that each of the images being formed on the front and back surfaces in a two-side print mode may have on the image on the other side, such that the image on each side is effectively corrected and reproduced appropriately to have comparable quality to what is obtained in a one-side print mode. By means of this two-side printing correction table 52, the two-side printing image data is converted to corrected outputting image data. The method of constructing the two-side printing correction table 52 will be described later in detail.

The computing section 54 constructs the front surface LUT and the back surface LUT in the printing image data converting section 50, as well as the two-side printing correction LUT 56 for appropriate image reproduction on the photographic print P. The methods of constructing the front surface LUT and the back surface LUT in the printing image data converting section 50 as well as the two-side printing correction LUT 56 will be described later in detail.

When an image is to be recorded on both the front and back surfaces of the recording medium M, the image recorded on the front or back surface may affect the image on the other side by changing, for example, the color tints or densities of the image; the two-side printing correction LUT 56 serves to suppress those effects and correct the image quality such that it will be comparable to what is obtained by image recording on one side only.

The two-side printing correction LUT 56 tabulates the amounts of correction that can suppress adverse effects such as the changes in color tint and density that result from a plurality of combinations of two patch colors, one being the color of a patch recorded on the front surface of the recording medium and the other of a patch on the back surface in the corresponding position. The method of constructing the two-side printing correction LUT 56 will be described later in detail.

In the table converting section 58, front- and back-surface image data pairs in each of which the two-side printing image data on a pixel in a patch on the front surface is combined with the image data for a pixel in a patch on the back surface in the corresponding position are correlated to the amounts of correction based on the color combinations as constructed in the two-side printing correction LUT 56. Then, the amounts of image data correction are calculated for each of the image data on the individual front-surface pixels and the image data on the individual back-surface pixels. In the next place, correction tables are constructed that respectively tabulate the amounts of image data correction on the individual front-surface pixels and those for the image data on the individual back-surface pixels. The constructed correction tables are outputted to the two-side printing correction table 52.

The chart generating section 60 stores the image data for recording the calibration chart (calibration chart data); it supplies the calibration chart data to the printing image data converting section 50 and the computing section 54 as the first step of calibration.

The chart generating section 60 has calibration chart data for at least two calibration charts, one to be used in the calibration of an image on either the front or back surface and the other in the calibration of images on two sides.

In the description, the calibration chart data used for one-side calibration is referred to as “one-side calibration chart data”. The calibration chart as obtained from the one-side calibration chart data is referred to as “one-side calibration chart”. The calibration chart data used for two-side calibration is referred to as “two-side calibration chart data”. The calibration chart as obtained from the two-side calibration chart data is referred to as “two-side calibration chart”.

Note that the calibration chart to be used in the present invention is not limited in any way and various kinds of calibration chart may be employed as they fit the calibration method to be implemented. An example of the calibration chart that may be employed in the calibration of an image on one side is an 8-level gray or monochromatic (C, M, Y) optical wedge. This calibration chart may be exemplified by one based on calibration chart data consisting of gray patches having identical proportions of C, M and Y and arranged at equal intervals to provide 8 levels of tone or one based on calibration chart data consisting of C, M and Y patches in three rows in each of which the individual monochromatic patches are arranged at equal intervals to provide 8 levels of tone.

The two-side calibration chart to be used in the calibration of an image on two sides may be such that a plurality of patches are formed on the front and back surfaces of the recording medium in such a way that any two corresponding patches, one on the front surface and the other on the back surface, are at least different in color. The two-side calibration chart consists of a plurality of black-and-white and color patches and all patches on the front and back surfaces are such that the patches on the front surface differ at least in color from the corresponding patches on the back surface. In a preferred mode, the patches on the front surface also differ in density from the corresponding patches on the back surface.

The recording medium species-related information section 62 is a site where recording medium's information such as transmittance and reflectance is accumulated about the recording medium M as it is contained in the magazines 22a and 22b. As already mentioned, a reader for reading the information about the recording medium M contained in the magazines 22a and 22b may be provided in the feed unit 12; in this case, the information thus read is entered into the recording medium species-related information section 62. if desired, an input means (not shown) may be used to enter information about the type of the accommodated recording medium M into the recording medium species-related information section 62. The recording medium species-related information section 62 outputs recording medium's information to the computing section 54 which is specific to the recording medium M in the magazines 22a and 22b.

If recording medium's information such as transmittance or reflectance is used as parameters in the computing section 54 for constructing the amounts of correction, steps such as density measurement can be simplified, leading to simplified construction of the two-side printing correction LUT 56. If desired, recording medium's information such as transmittance or reflectance may be used as additional parameters for constructing the amounts of correction and this contributes to enhancing the precision with which the changes in color tint or density can be suppressed by the two-side printing correction LUT 56.

Note that the recording medium species-related information section 62 is not essential and may be omitted to either simplify the construction of the two-side printing correction LUT 56 or if there is no need to increase the precision of its construction.

When an image is to be recorded on both the front and back surfaces of the recording medium M, the image recorded on the front or back surface may affect the image on the other side by changing, for example, the color tints or densities of the image; in order to suppress those effects and obtain images that are comparable in quality to what is obtained by image recording on one side only, the two-side printing correction LUT 56 is provided in the image recording apparatus 10 in the embodiment under consideration. The image recording apparatus 10 further includes the table converting section 58 for constructing correction tables listing the amounts of image data correction of the image data for the individual pixels on the front and back surfaces in the two-side printing image data; by setting these correction tables in the two-side printing correction table 52, the image data for the front and back surfaces in the outputting image data can be subjected to color- and density-based corrections. As a result, one can obtain corrected outputting image data that is suppressed in adverse effects such as the changes in color tint and density. Using the corrected outputting image data, the image forming unit 16 can make a photographic print that is suppressed in the effect the image formed on the front or back surface may have on the image formed on the other side. This photographic print has comparable image quality to one that has an image formed on just one side of the recording medium M.

In the embodiment under consideration, a silver halide photographic image recording apparatus is used as the image forming unit 16 but this is not the sole case of the present invention and an electrophotographic, ink-jet, hot melt or some other image recording system may be employed as chosen appropriate for the required image quality or print format.

We then describe the methods of constructing the two-side printing correction LUT 56, the table converting section 58 and the two-side printing correction table 52 which are provided in the control unit 20 of the image recording apparatus 10 in the embodiment under consideration (the methods may be collectively called the method of calibrating the image recording apparatus 10 of the present invention).

The method of calibrating the image recording apparatus 10 for recording image on one side, either the front or back surface, of the recording medium M according to the second aspect of the present invention is performed after both the front and back surfaces of the recording medium M have been calibrated.

Let us first describe the process of calibrating the front surface LUT and the back surface LUT for recording an image on either the front or back surface of the recording medium M in the image recording apparatus 10 in the embodiment under consideration.

In the embodiment under consideration, the front surface LUT and the back surface LUT can be calibrated by any known method.

To begin with, the chart generating section 60 supplies one-side calibration chart data into the printing image data converting section 50 and the computing section 54. Based on the supplied one-side calibration chart data, a plurality of patches are recorded on the front surface of the recording medium M by the first image forming section 30a. The densities of the respective patches on the one-side calibration chart are measured with the densitometer in the first density measuring section 18a. The results of measurement in the first density measuring section 18a are outputted to the computing section 54. Then, the difference between the reference density of each patch predetermined by the one-side calibration chart based on the one-side calibration chart data and the measured density of the corresponding patch is calculated. If the calculated difference is within an allowable range, the process of calibration immediately ends without constructing any LUT in the computing section 54.

If the calculated difference is outside the allowable range, a new correction LUT is constructed in the computing section 54 in such a way that the differential density is within the allowable range for all of the patches recorded on the front surface of the recording medium M and the new correction LUT is used to rewrite (update) the front surface LUT in the printing image data converting section 50; alternatively, an entirely new correction LUT is set to replace the front surface LUT. Thereafter, the chart generating section 60 outputs one-side calibration chart data again into the printing image data converting section 50 to form a one-side calibration chart. The densities of the respective patches on the one-side calibration chart are measured with the densitometer in the first density measuring section 18a and the results of measurement are outputted to the computing section 54. Again, the difference between the reference density of each patch based on the one-side calibration chart data and the measured density of the corresponding patch is calculated. This process is repeated until the calculated difference is within the allowable range, and the front surface LUT is rewritten or an entirely new correction LUT is set to replace the front surface LUT.

The same procedure is taken for calibration of the back surface. The chart generating section 60 supplies one-side calibration chart data into the printing image data converting section 50 and the computing section 54 and a one-side calibration chart is formed by the second image forming section 30b. The densities of the respective patches on the one-side calibration chart are measured with the densitometer in the first density measuring section 18a and the results of measurement are outputted to the computing section 54. Then, the difference between the reference density of each patch based on the one-side calibration chart data and the measured density of the corresponding patch is calculated. The process is repeated until the calculated difference is within an allowable range, and the back surface LUT is rewritten or an entirely new correction LUT is set to replace the back surface LUT.

This is how the front surface LUT and the back surface LUT are calibrated for recording image on either the front or the back surface of the recording medium M in the image recording apparatus 10 according to the embodiment under consideration.

With calibration having been carried out for the front and back surfaces of the recording medium M, the chart generating section 60 first outputs two-side calibration chart data into the printing image data converting section 50 and the computing section 54, and various patches are recorded on both the front and back surfaces of the recording medium M by the first image forming section 30a and the second image forming section 30b to form a two-side calibration chart.

The two-side calibration chart consists of a plurality of black-and-white and color patches and all patches on the front and back surfaces are such that the patches on the front surface are at least different in color from the corresponding patches on the back surface. Since the image forming unit 16 has been calibrated, the color and density of each patch are reproduced with an allowable range of precision.

In the next step, the density of each of the patches on the two-side calibration chart and the position where it forms image on the recording medium M (i.e., the first position information) are measured by the first density measuring section 18a and the second density measuring section 18b.

Then, the difference between the reference density of each patch (pixel information) predetermined by the two-side calibration chart based on the two-side calibration chart data and the measured density of the corresponding patch is calculated.

Consequently, the difference in measured density is determined as it is based on the combinations of the patches on the front and back surfaces of the recording medium M. In other words, the amounts of changes in the color tint of each patch and those in its density are determined as they depend on the combinations of the colors of the individual patches.

Speaking of the patches formed on the front and back surfaces of the recording medium M, those which make pairs with respect to the front and back surfaces of the recording medium are specified by the position information (the second position information) which shows the position where each patch in the chart data is formed on the recording medium. In addition, the positions of the patches as measured with the first density measuring section 18a and the second density measuring section 18b are outputted to the computing section 54 together with their measured densities. As a result, one can specify which of the patches on the recording medium M is indicated by a measured density, as well as specifying the densities of the patches formed on the front surface of the recording medium M and those of the patches on the back surface. In this way, the amounts of changes in color tint and density due to the combinations of various colors are determined and the two-side printing correction LUT 56 is constructed on the basis of those amounts of changes.

A word must be said about the case where the two-side printing correction LUT 56 is constructed for the second and subsequent times; if there are no substantial changes in the quality of the recording medium M, the characteristics of the machine or if aging and other changes are small, there is no need to make measurement for each of the patches on the front and back surfaces of the two-side calibration chart and instead, measurement is made for the respective patches on either the front or back surface of the two-side calibration chart and the two-side printing correction LUT 56 may be constructed by interpolating the amounts of correction that were calculated for the previous construction of the two-side printing correction LUT 56.

If there are substantial changes in the quality of the recording medium M, the characteristics of the machine or if aging and other changes are significant, or if one wants to perform calibration with high precision, it is preferred to perform calibration in the usual manner as described above by making measurement for the individual patches on the front and back surfaces of the two-side calibration chart.

In the next place, we describe the methods of constructing the table converting section 58 and the two-side printing correction table 52.

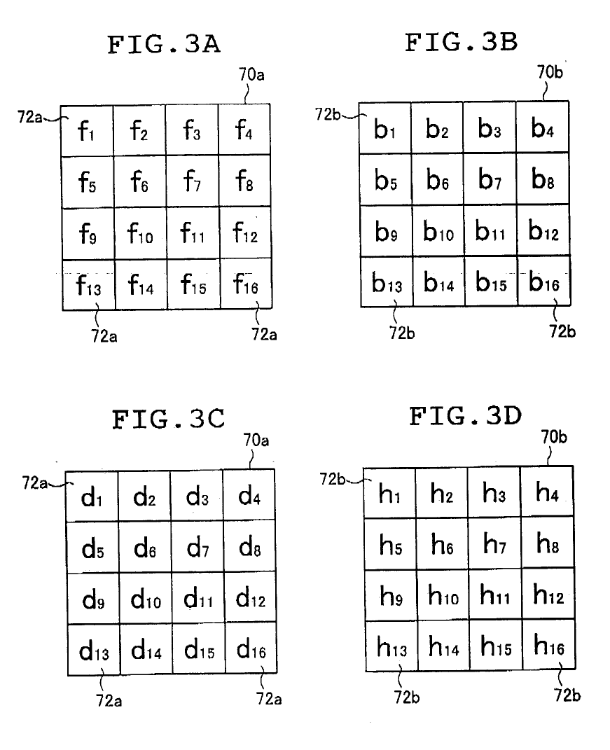

Assume, for example, the case where the image on the front surface which is indicated by 70a in FIG. 3A consists of 16 pixels 72a which are a series of image data f₁-f₁₆; also assume that the image on the back surface which is indicated by 70b in FIG. 3B consists of 16 pixels 72b which are a series of image data b₁-b₁₆. Based on these assumptions, the image data for a pixel on the front surface is combined with the image data for the corresponding pixel on the back surface to construct image data pairs with respect to the front and back surfaces which are represented by (f₁,b₄), (f₂,b₃), . . . , (f₁₆,b₁₃).

Then, the image data pairs (f₁,b₄), (f₂,b₃), . . . , (f₁₆,b₁₃) are correlated to the amounts of correction tabulated in the two-side printing correction LUT 56 and the amounts of image data correction are calculated for the image data f₁-f₁₆ and b₁-b₁₆ in the image data pairs (f₁,b₄), (f₂,b₃), . . . , (f₁₆,b₁₃) as shown in FIGS. 3C and 3D, where the calculated amounts of image data correction are represented by d₁-d₁₆ and h₁-h₁₆, respectively.

Note that the amounts of image data correction d₁-d₁₆ are calculated for the image data f₁-f₁₆ for the individual pixels 72a on the front surface, and the amounts of image data correction h₁-h₁₆ are calculated for the image data b₁-b₁₆ for the individual pixels 72b on the back surface.

In the next step, a correction table (not shown) is constructed that shows the amounts of image data correction d₁-d₁₆ for the individual pixels 72a on the front surface and another correction table (also not shown) is constructed that shows the amounts of image data correction h₁-h₁₆ for the individual pixels 72b on the back surface.

Then, the correction table showing the amounts of image data correction d₁-d₁₆ for the individual pixels 72a and the correction table showing the amounts of image data correction h₁-h₁₆ for the individual pixels 72b are outputted to the two-side printing correction table 52 to modify it. This completes the process of calibrating the image processing apparatus 10.

According to the method of calibrating the image recording apparatus 10 in the embodiment described above, there is constructed the two-side printing correction table 52 which performs correction of color tint and density for the front-surface image data and the back-surface image data in the outputting image data to yield corrected outputting image data that is suppressed in adverse effects such as changes in the color tints and densities of image.

Note that in the table converting section 58 of the embodiment described above, the amounts of image data correction may be adjusted in accordance with the importance of each of the images to be recorded on the front surface Pf and the back surface Pb of a photographic print P. For example, if the image quality on the front surface Pf is important, a correction table is constructed by determining the amounts of image data correction for the printing image data on the front surface Pf but without determining the amounts of image data correction for the printing image data on the back surface Pb. In this way, the image data for the image to be formed on the front or back surface may be weighted by the table converting section 58 in accordance with the required image quality to set appropriate correction tables.

We now describe the method of recording images on two sides by the image recording apparatus 10 in the embodiment under consideration.

First, the printing image data input unit 40 supplies the printing image data converting section 50 and the table converting section 58 with the two-side printing image data for recording images on two-side or both surfaces of the recording medium M.

In the next step, the printing image data is converted to outputting image data in the printing image data converting section 50. In the table converting section 58, the printing image data and the two-side printing correction LUT 56 are used to construct two correction tables, one for the individual pixels in the image on the front side and the other for the individual pixels in the image on the back side. These two correction tables set up the two-side printing correction table 52.

Subsequently, the outputting image data is subjected to color tint and density corrections for the front and back surfaces by means of the two-side printing correction table 52. This yields corrected outputting image data which is free of any adverse effects such as the changes in color tint and density on the front and back surfaces. The corrected outputting image data is then outputted to the image forming unit 16.

Based on the corrected outputting image data, the image forming unit 16 records images on two-side of the recording medium M, thereby making a photographic print P. The photographic print P is characterized in that the effects each of the images recorded on the front surface Pf and the back surface Pb will have on the image formed on the other side are effectively suppressed to provide image quality comparable to that of a photographic print made by recording image on just one side of the recording medium M.

Thus, the image recording apparatus 10 in the embodiment described above can form high-quality images on two-side of the recording medium M and the images recorded on the front surface Pf and the back surface Pb of the photographic print P produced are effectively suppressed in the changes of color tint and density to ensure that it has comparable image quality to a photographic print with image formed on just one side.

Needless to say, the image recording apparatus 10 in the embodiment described above may be operated to record image on just one side (either the front or the back surface) of the recording medium M and in this case, too, the apparatus can produce photographic prints having high-quality image.

While the image recording apparatus according to the first aspect of the present invention and the method of calibrating the apparatus according to the second aspect of the invention have been described in detail on the foregoing pages with reference to a preferred embodiment, the invention is in no way limited to that embodiment and it should be understood that various improvements and modifications are possible without departing from the scope and spirit of the invention.

What is claimed is:

1. An image recording apparatus comprising;
an image forming unit which forms an image or images on a front surface, a back surface or both of a recording medium based on printing image data;
a chart generating section which generates chart image data for generating a calibration chart which has plural pairs of two patches formed on front and back surfaces of said recording medium in such a way that two corresponding patches of one pair, one on said front surface and the other on said back surface, are at least different in color, and outputs said chart image data as said printing image data to said image forming unit, as well as stores first image information and first position information showing a position to be formed on said recording medium for each patch of said plural pairs of two patches to be formed on both surfaces of said calibration chart;
an acquisition unit which acquires second image information and second position information showing a formed position on said recording medium for each patch recorded on at least one surface of said calibration chart formed by said image forming unit based on said chart image data output from said chart generating section;
a computing section which, based on said second image information and said second position information for each patch that have been acquired by said acquisition unit as well as said first image information and said first position information for each patch that have been stored by said acquisition unit, calculates reference correction amounts for recording image on both the front and back surfaces in said chart generating section; and
a printing image data correcting section which calculates amounts of image data correction of said printing image data for each of pixels in each of said images based on the calculated reference correction amounts, image information for each of pixels in each of said images to be formed on said front and back surfaces of said recording medium and position information to be formed for each of said pixels in each of said images on said front and back surfaces of said recording medium, and corrects said printing image data of said images for forming on said front and back surfaces of said recording medium using the calculated amounts of image data correction,
wherein said image forming unit forms, based on said printing image data corrected by said printing image data correcting section, said images on said front and back surfaces of said recording medium, respectively.

2. The image recording apparatus according to claim 1, further comprising:
a recording medium species-related information section which stores transmittance and reflectance of said recording medium,
wherein said computing section calculates said reference correction amounts in consideration of said transmittance and said reflectance of said recording medium stored in said recording medium species-related information section.

3. A method of calibrating an image recording apparatus which is capable of forming an image or images on a front surface, a back surface or both of a recording medium based on printing image data, comprising the steps of:
calibrating image formation due to said image recording apparatus on each of front and back surfaces of said recording medium;
generating with said image recording apparatus a calibration chart which has plural pairs of two patches formed on front and back surfaces of said recording medium in such a way that two corresponding patches of one pair, one on said front surface and the other on said back surface, are at least different in color;
measuring second image information and second position information showing a formed position on said recording medium for each patch recorded on at least one surface of the formed calibration chart; and
calculating reference correction amounts for recording image on both the front and back surfaces of said recording medium based on said second image information and said second position information for each patch that have been measured as well as first image information and first position information for each patch that have been used for generating said calibration chart with said image recording apparatus.

4. The method according to claim 3, further comprising the steps of:
calculating amounts of image data correction of said printing image data for each of pixels in each of said images based on the calculated reference correction amounts, image information for each of pixels in each of said images to be formed on said front and back surfaces of said recording medium and position information to be formed for each of said pixels in each of said images on said front and back surfaces of said recording medium; and
correcting said printing image data of said images for forming on said front and back surfaces of said recording medium using the calculated amounts of image data correction.

5. The method according to claim 3, wherein said step of calculating said reference correction amounts calculates said reference correction amounts in consideration of transmittance and reflectance of said recording medium.
